(19) United States
(12) Patent Application Publication
(10) Pub. No.: US 2016/0038869 A1
(43) Pub. Date: Feb. 11, 2016

(54) BAG FILTER EXTENDER

(71) Applicant: CAMFIL USA, INC., Riverdale, NJ (US)

(72) Inventors: Michael T. KRAUSE, Plainfield, NJ (US); Joseph J. GORMAN, Vernon, NJ (US); Thomas Alan RUMPLER, West Chester, OH (US)

(21) Appl. No.: 14/455,219

(22) Filed: Aug. 8, 2014

(51) Int. Cl. B01D 46/42; B01D 46/00; B01D 46/02

(52) U.S. Cl. CPC B01D 46/4227; B01D 46/023; B01D 46/002

(57) ABSTRACT

A bag filter extender that comprises a quadrilateral tube is provided. The bag filter extender is configured to allow longer bag filter assemblies to be utilized in a holding frame.

### BACKGROUND

1. Field of the Disclosure

Embodiments of the present disclosure generally relate to a bag filter extender.

2. Description of the Related Art

An air filtration system enhances air quality by removing impurities, such as dust, pollen, mold, and bacteria, from the air. The air filtration system has a holding frame for mounting a bag filter assembly. The bag filter assembly has a filter frame for supporting one or more filter bags comprised of a media configured to remove air impurities. As air flows into the bag filter assembly and through the filter bags, the air impurities are captured by the filter bag media.

Since existing holding frames are permanently installed in a larger surrounding structure, such as an air duct of a building ventilation system, the bag filter assembly is designed to be easily removed from the holding frame when needed for replacement. Specifically, the filter frame of the bag filter assembly is releasably coupled to the holding frame. When installed, the filter frame of the bag filter assembly is coupled to the front end of the holding frame such that the filter bags extend through and out of the back end of the holding frame.

Deeper bag filter assemblies have a larger surface area for filtering out air impurities, which increases the service life and reduces energy consumption. However, the depth or length of the bag filter assembly is limited to the space available behind the holding frame since the filter bags extend out of the back end of the holding frame. For example, the back end of the holding frame may be located close to a wall or a bend in an air duct, which can obstruct the filter bags extending out of the back end of the holding frame. Moving an existing, permanently installed holding frame so that a longer bag filter can be used is impractical and expensive. Thus, the efficiency of existing air filtration systems can be limited depending on the location of the holding frame.

Therefore, there is a need for apparatus and methods for allowing use of longer bag filter assemblies with existing holding frames of air filtration systems.

### SUMMARY

A bag filter extender comprising a quadrilateral tube having a centerline extending from a first open end to a second open end, the quadrilateral tube having a width at the first open end within a range of about 293 mm to about 598 mm and a depth within a range of about 278 mm to about 328 mm. The quadrilateral tube comprising an inner shoulder formed at the first open end and an outer shoulder formed at the second open end, wherein the inner and outer shoulders are parallel to each other and perpendicular to the centerline of the quadrilateral tube, and wherein an outer perimeter of the inner shoulder is substantially equal to or less than a size of an outer perimeter of a holding frame.

A method for reconfiguring a filtration system configured for use with a longer bag filter assembly comprising installing one open end of a bag filter extender in a holding frame, the bag filter extender having an opposite open end configured to accept a bag filter assembly. The method further comprising removing a first bag filter assembly from the holding frame, the first bag filter assembly having a filter media of a first length. The method further comprising installing a second bag filter assembly in the opposite open end of the bag filter extender, the second bag filter assembly bag filter assembly having a filter media of a second length that is greater than the first length of the filter media of the first bag filter assembly.

### BRIEF DESCRIPTION OF THE DRAWINGS

So that the manner in which the above recited features can be understood in detail, a more particular description of the embodiments briefly summarized above may be had by reference to the embodiments below, some of which are illustrated in the appended drawings. It is to be noted, however, that the appended drawings illustrate only typical embodiments and are therefore not to be considered limiting of its scope, for the embodiments may admit to other equally effective embodiments.

FIG. 1 illustrates a front perspective view of a bag filter extender, according to one embodiment disclosed herein.

FIG. 2 illustrates a rear perspective view of the bag filter extender, according to one embodiment disclosed herein.

FIG. 3 illustrates a front perspective exploded view of a bag filter assembly, the bag filter extender, and a holding frame, according to one embodiment disclosed herein.

FIG. 4 illustrates a vertical sectional view of the bag filter assembly, the bag filter extender, and the holding frame, according to one embodiment disclosed herein.

FIG. 5A illustrates a side sectional view of the bag filter assembly, the bag filter extender, and the holding frame, according to one embodiment disclosed herein.

FIG. 5B illustrates an enlarged view of a portion of the side sectional view of the bag filter assembly, the bag filter extender, and the holding frame, according to one embodiment disclosed herein.

FIG. 6 illustrates a horizontal sectional view the bag filter assembly, the bag filter extender, and the holding frame, according to one embodiment disclosed herein.

FIG. 7A illustrates a top sectional view of the bag filter assembly, the bag filter extender, and the holding frame, according to one embodiment disclosed herein.

FIG. 7B illustrates an enlarged view of a portion of the top sectional view of the bag filter assembly, the bag filter extender, and the holding frame, according to one embodiment disclosed herein.

### DETAILED DESCRIPTION

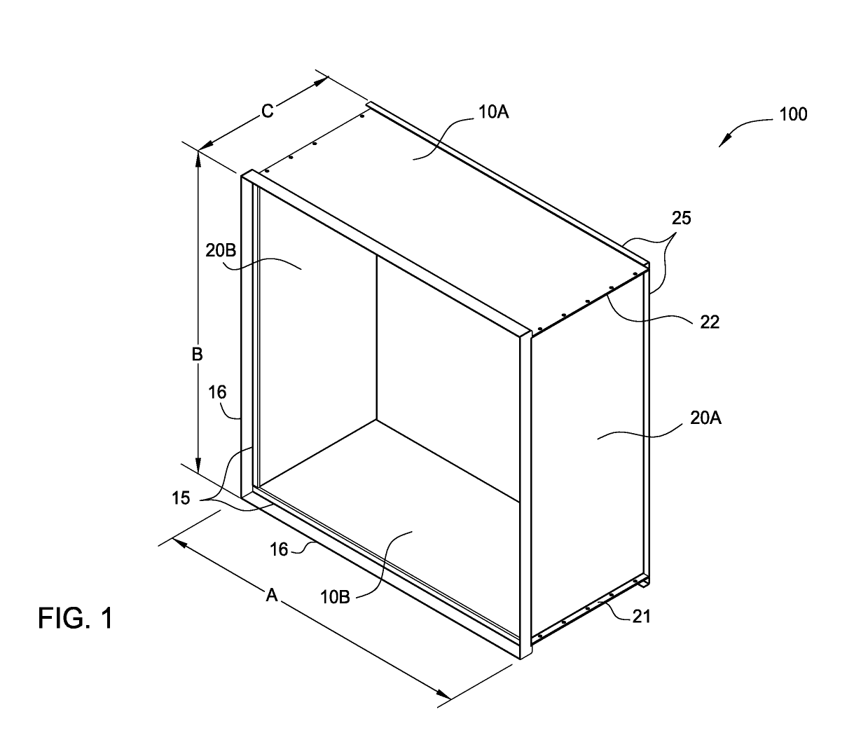

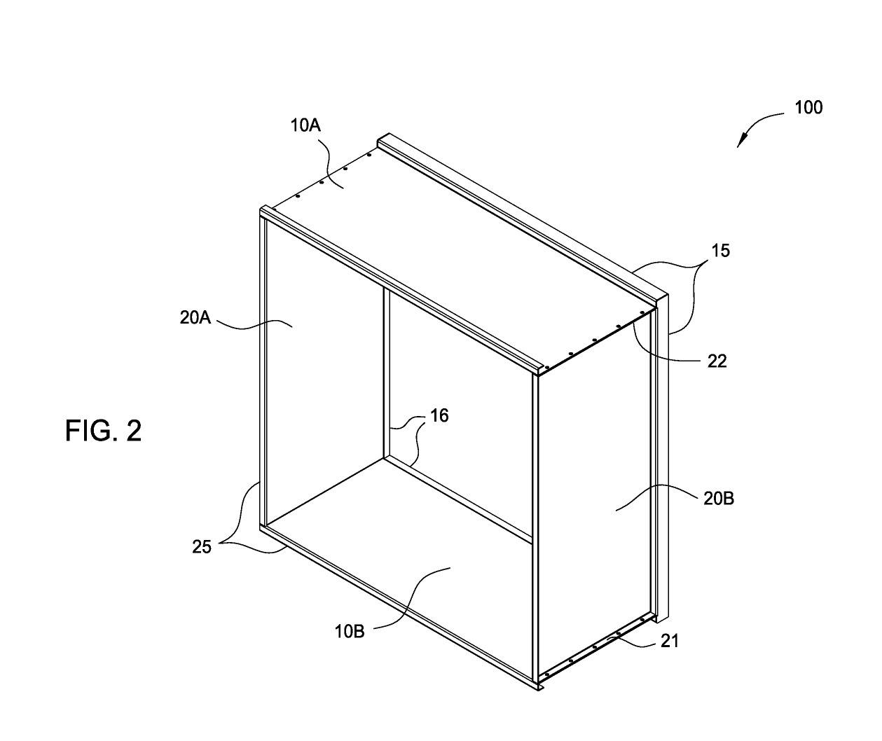

FIGS. 1 and 2 illustrate front and rear perspective views, respectively, of a bag filter extender 100, according to one embodiment disclosed herein. As illustrated, the extender 100 has four sides including an upper panel 10A, a lower panel 10B, a right side panel 20A, and a left side panel 20B. The upper and lower panels 10A, 10B have a width A within a range of about 293 mm to about 598 mm, and a depth C within a range of about 278 mm to about 328 mm. The right and left side panels 20A, 20B have a height B within a range of about 293 mm to about 598 mm, and substantially the same depth C. The width A and height B are selected to accommodate a bag filter assembly while engaging a holding frame, while not interfering with neighboring holding frames.

The panels 10A, 10B, 20A, 20B are coupled together, such as by welded, riveted, and/or threaded connections, to form a substantially square or rectangular shaped tubular structure (e.g. a quadrilateral tube) with front (first) open end, a back (second) open end, and an open interior disposed between the front and back open ends into which a bag filter assembly can be inserted. The right and left side panels 20A, 20B have outer edge surfaces 21 that contact corresponding outer edge surfaces 22 of the top and bottom panels 10A, 10B, through which one or more rivets can be placed on the exterior of the extender 100 to connect the panels 10A, 10B, 20A, 20B together, thereby leaving a substantially flush open interior surface of the extender 100 through which a bag filter assembly can be inserted without obstruction. Alternatively, the panels 10A, 10B, 20A, 20B may be an integral single piece member. The panels 10A, 10B, 20A, 20B can be formed from materials such as galvanized steel, aluminum, wood product, glass-reinforced plastic, plastic, or any other material sufficient to structurally support a bag filter assembly.

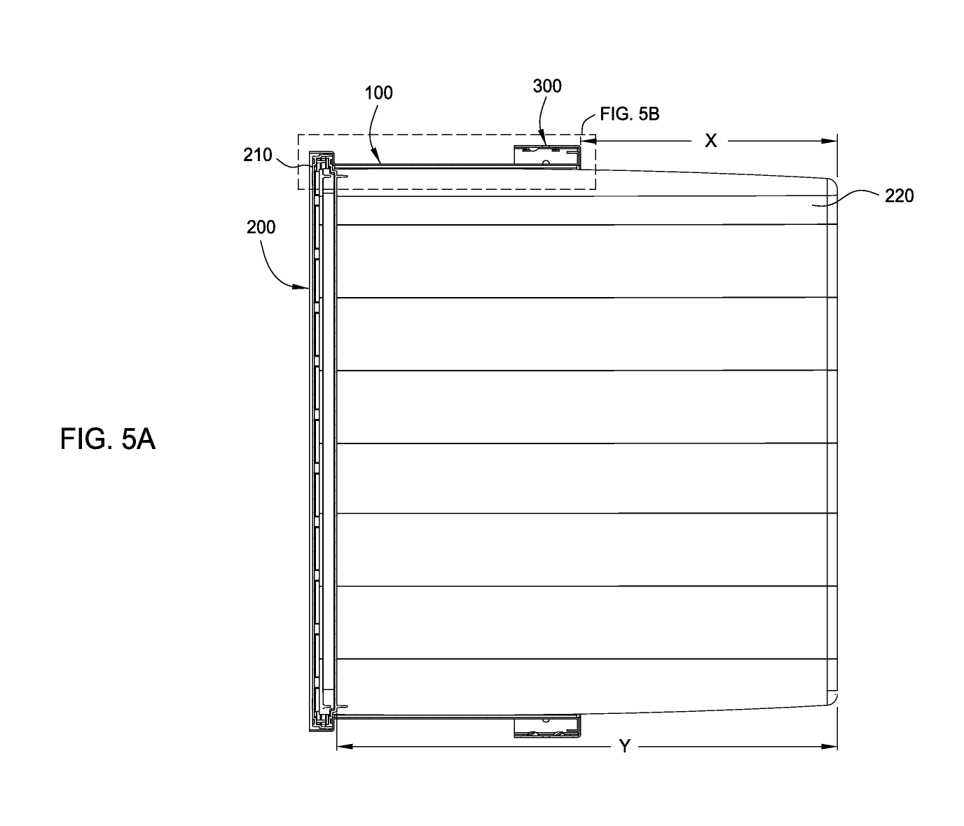

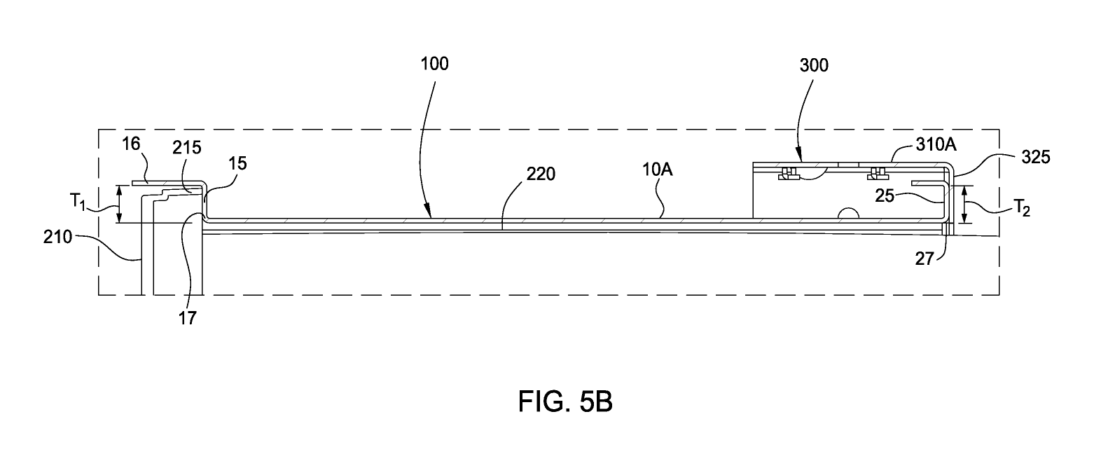

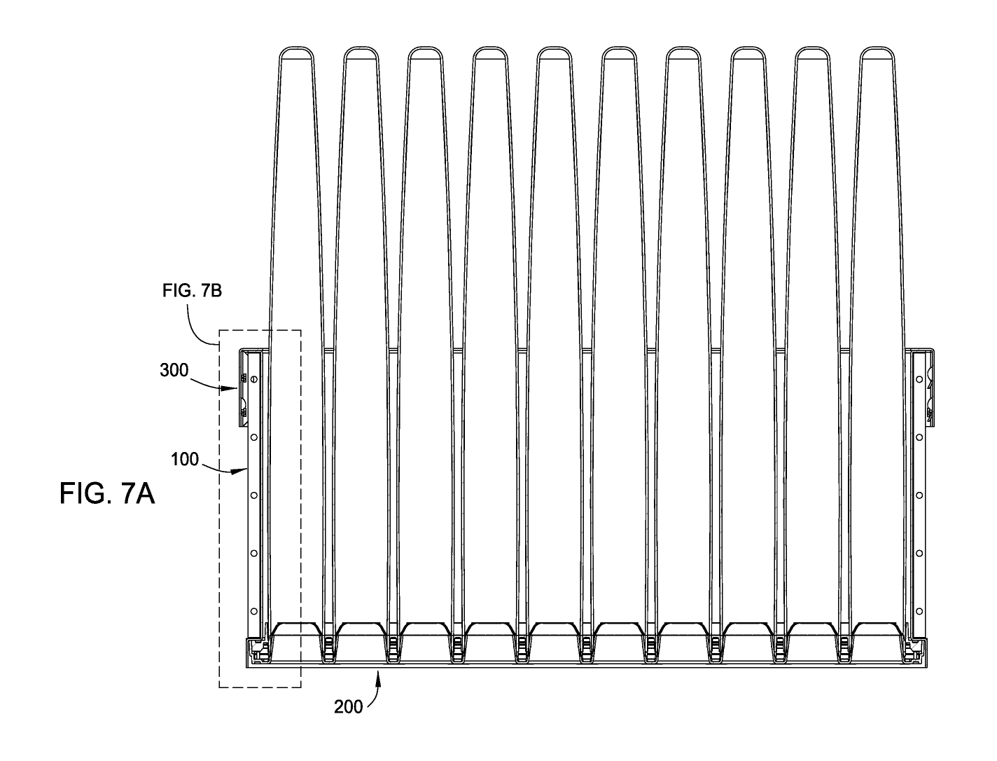

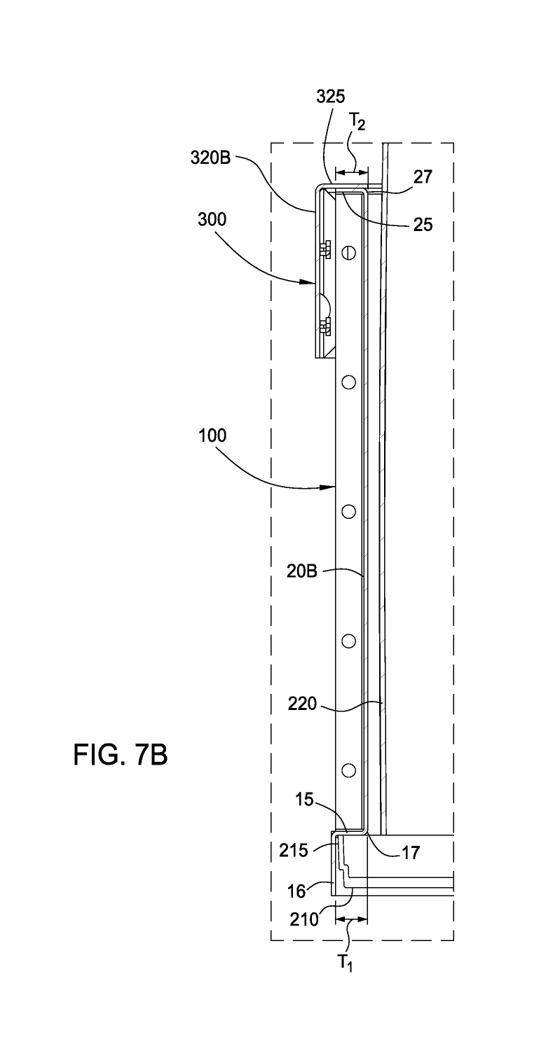

The front sides of the panels 10A, 10B, 20A, 20B form an inner shoulder 15 and an outer lip portion 16 circumscribing the inner shoulder 15 for supporting the front end of a bag filter assembly. The inner shoulder 15 has a width T1 (referenced in FIGS. 5B and 7B) within a range of about 10 mm to about 15 mm. The inner shoulder 15 is substantially perpendicular to the centerline of the extender 100, and is substantially equidistant from the top, bottom, right, and left sides of the extender 100.

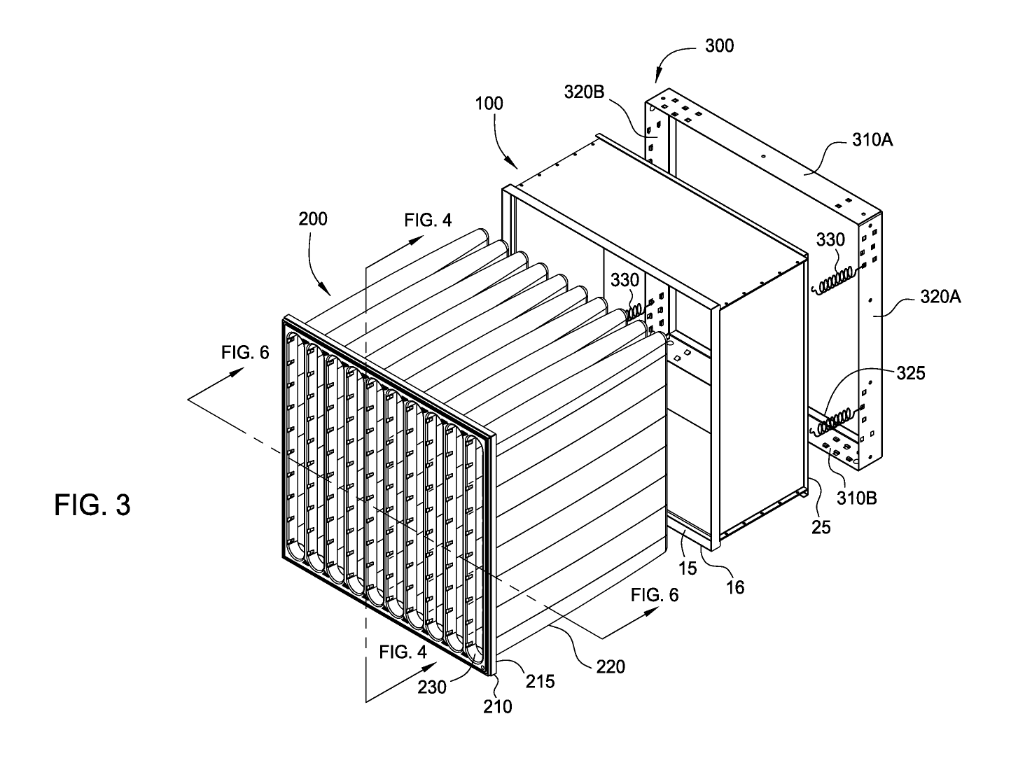

The rear sides of the panels 10A, 10B, 20A, 20B form an outer shoulder 25 for inserting into a holding frame. The outer shoulder 25 has a width T2 (referenced in FIGS. 5B and 7B) within a range of about 10 mm to about 15 mm. The outer shoulder 25 is substantially perpendicular to the centerline of the extender 100, and is substantially equidistant from the top, bottom, right, and left sides of the extender 100. The outer shoulder 25 and the inner shoulder 25 are substantially parallel to each other. The extender 100 is configured to couple a bag filter assembly to a holding frame as further illustrated in FIG. 3.

FIG. 3 is a front perspective exploded view of an air filtration system comprising a bag filter assembly 200, the bag filter extender 100, and a holding frame 300, according to one embodiment disclosed herein. The bag filter assembly 200 includes a filter frame 210 and a filter media 220 in the form of a plurality of individual filter bags with the open ends of the individual filter bags coupled to the filter frame 210. The filter frame 210 also includes a plurality of openings 230 through which air can flow and be directed into the interior of the filter media 220. Air impurities are captured by the filter media 220 to clean the air flowing through the bag filter assembly 200. The filter media 220 may be formed out of glass, polymer fibers, and/or any other similar type of filtering media. The bag filter assembly 200 includes a width within a range of about 280 mm to about 600 mm, a height within a range of about 280 mm to about 900 mm, and a depth of about 280 mm to about 900 mm. The bag filter assembly 200 may alternatively have other sizes.

The holding frame 300 has four sides including an upper panel 310A, a lower panel 310B, a right side panel 320A, and a left side panel 320B. The panels 310A, 310B, 320A, 320B are coupled together, such as by welded, riveted, and/or threaded connections, to form a substantially square or rectangular shaped tubular structure (e.g. a quadrilateral tube) with an open interior into which the extender 100 can be inserted. The panels 310A, 310B, 320A, 320B may alternatively be an integral single piece member. The panels 310A, 310B, 320A, 320B can be formed from materials such as galvanized steel, aluminum, wood product, glass-reinforced plastic, plastic, or any other material sufficient to structurally support the extender 100. The rear sides of the panels 310A, 310B, 320A, 320B form an inner shoulder 325 for supporting the rear end of the extender 100. The holding frame 300 also includes one or more attachment members 330, such as spring clips, that are configured to securely attach the extender 100 to the holding frame 300.

The bag filter assembly 200 is inserted into the front end of the extender 100 such that the filter media 220 extends through the interior of the extender 100. An outer shoulder 215 of the filter frame 210 contacts the inner shoulder 15 of the extender 100, which prevents the bag filter assembly 200 from being inserted entirely through the extender 100. Similarly, the extender 100 with the bag filter assembly 200 is inserted into the front end of the holding frame 300 such that the filter media 220 extends through the interior of the holding frame 300. The outer shoulder 25 of the extender 100 contacts the inner shoulder 325 of the holding frame 300, which prevents the extender 100 from being inserted entirely through the holding frame 300. The extender 100 can be attached to the holding frame 300 using the attachment members 330. Similar or different types of attachment members can be used to attach the bag filter assembly 200 to the extender 100.

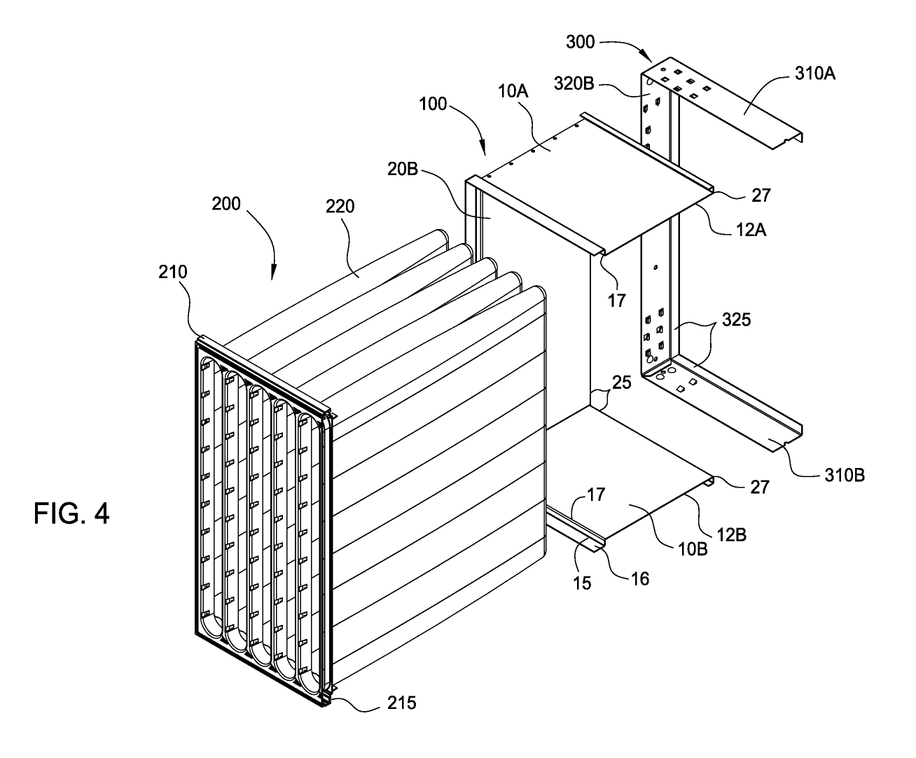

FIG. 4 illustrates a vertical sectional view of the bag filter assembly 200, the extender 100, and the holding frame 300, according to one embodiment disclosed herein. As illustrated, the inner shoulder 15 at the front ends of the top and bottom panels 10A, 10B may form part of a substantially L-shaped configuration. The outer shoulder 25 at the rear ends of the top and bottom panels 10A, 10B may form part of a substantially J-shaped configuration. The interior edge 17 of the inner shoulder 15 and the interior edge 27 of the outer shoulder 25 of the top and bottom panels 10A, 10B are formed by bending the top and bottom panels 10A, 10B so that the interior edges 17, 27 are curved and have no sharp edges to prevent damage, such as tearing, of the filter media 220 when inserted into the extender 100.

FIG. 5A illustrates a side sectional view of the bag filter assembly 200 inserted into the extender 100 and the holding frame 300, as well as the extender 100 inserted into the holding frame 300, according to one embodiment disclosed herein. As illustrated, the filter media 220 extends a shortened distance X, such as about 12 inches, from the rear of the holding frame 300 by using the extender 100. Normally, without the use of the extender 100, the filter frame 210 is supported within the holding frame 300 such that the entire length Y, such as about 22 inches, of the filter media 220 extends out from the rear of the holding frame 300. The extender 100 provides the advantage of using longer bag filter assemblies 200 (which have deeper filter bags with greater surface areas for filtering out air impurities, thereby increasing dust holding capacity for longer service life, as well as lowering pressure drop for lower energy consumption), while maintaining or even reducing the distance that the filter media 220 extends out from the rear end of the holding frame 300 when space behind the holding frame 300 is limited.

FIG. 5B illustrates an enlarged view of a portion of the side sectional view of the bag filter assembly 200, the extender 100, and the holding frame 300, according to one embodiment disclosed herein. As illustrated, the outer shoulder 215 of the filter frame 210 is in contact with the inner shoulder 15 of the extender 100. The outer lip portion 16 surrounds the filter frame 210. The outer perimeter of the outer lip portion 16 is substantially equal to or less than the outer perimeter of the holding frame 300. The inner shoulder 15 at the front end of the top panel 10A may be part of a substantially L-shaped configuration. The interior edge 17 of the inner shoulder 15 has a curved bend to prevent damaging of the filter media 220 when being inserted into the extender 100. As further illustrated in FIG. 5B, the outer shoulder 25 of the extender 100 is in contact with the inner shoulder 325 of the holding frame 300. The outer shoulder 25 at the rear end of the top panel 10A may form part of a substantially J-shaped configuration. The interior edge 27 of the outer shoulder 25 has a curved bend to prevent damaging of the filter media 220 when being inserted into the extender 100.

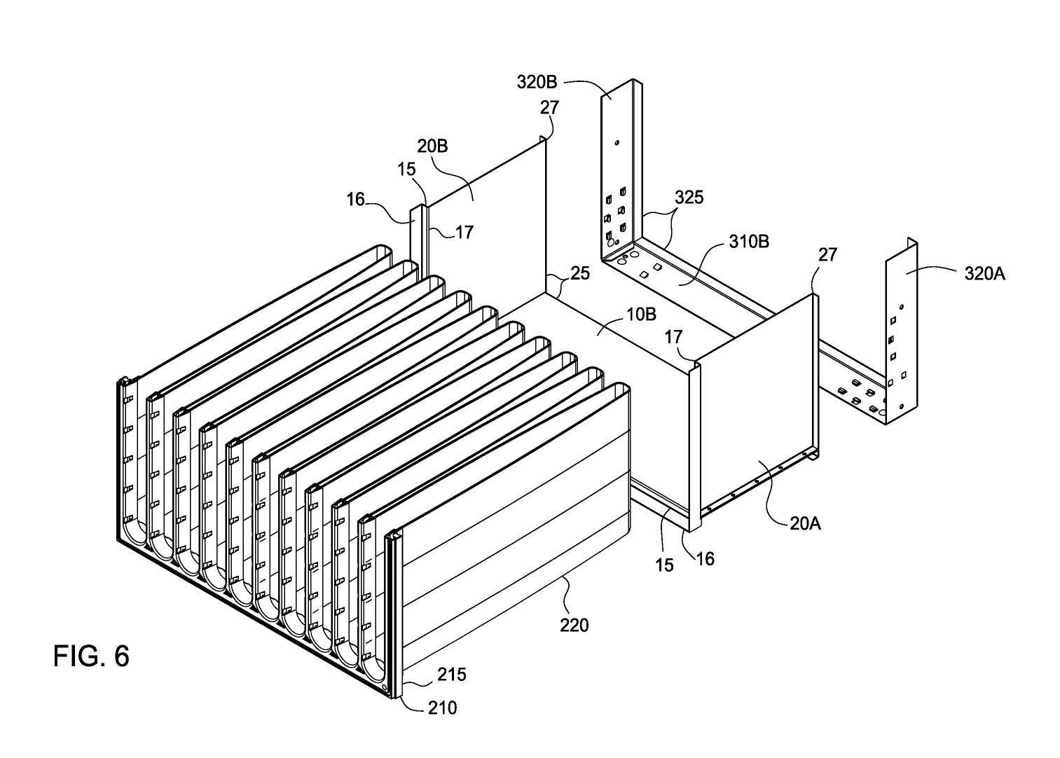

FIG. 6 illustrates a horizontal sectional view of the bag filter assembly 200, the extender 100, and the holding frame 300, according to one embodiment disclosed herein. As illustrated, the inner shoulder 15 at the front ends of the right and left side panels 20A, 20B may form part of a substantially L-shaped configuration. The outer shoulder 25 at the rear ends of the right and left side panels 20A, 20B also may form part of a substantially L-shaped configuration. The interior edge 17 of the inner shoulder 15 and the interior edge 27 of the outer shoulder 25 of the right and left side panels 20A, 20B are formed by bending the right and left side panels 20A, 20B so that the interior edges 17, 27 are curved and have no sharp edges to prevent damage, such as tearing, of the filter media 220 when inserted into the extender 100.

FIGS. 7A and 7B illustrate a side sectional view of the bag filter assembly 200 inserted into the extender 100 and the holding frame 300, as well as the extender 100 inserted into the holding frame 300, according to one embodiment disclosed herein. As illustrated, the outer shoulder 215 of the filter frame 210 is in contact with the inner shoulder 15 of the extender 100. The outer lip portion 16 surrounds the filter frame 210. The outer lip portion 16 surrounds the filter frame 210. The outer perimeter of the outer lip portion 16 is substantially equal to or less than the outer perimeter of the holding frame 300. The inner shoulder 15 at the front end of the left side panel 20B may form part of a substantially L-shaped configuration. The interior edge 17 of the inner shoulder 15 has a curved bend to prevent damaging of the filter media 220 when being inserted into the extender 100. As further illustrated in FIG. 7B, the outer shoulder 25 of the extender 100 is in contact with the inner shoulder 325 of the holding frame 300. The outer shoulder 25 at the rear end of the left side panel 20B may form part of a substantially L-shaped configuration. The interior edge 27 of the outer shoulder 25 has a curved bend to prevent damaging of the filter media 220 when being inserted into the extender 100.

In one embodiment, the holding frame 300 may be permanently installed in a larger surrounding structure (an air duct of a building ventilation system for example) such that the space available behind the holding frame 300 is limited. Longer bag filter assemblies have a larger surface area for filtering out air impurities, which increases dust holding capacity for longer service life, as well as lowers pressure drop for lower energy consumption. The length of the bag filter assembly 200, however, is limited to the space available behind the holding frame 300, since the bag filter assembly 200 is normally coupled directly to the holding frame 300 such that substantially the entire length of the filter media 220 extends out of the back end of the holding frame 300.

The extender 100 enables longer bag filter assemblies 200 to be used on existing holding frames 300 where space available behind the holding frame 300 is limited, without having to move the holding frame 300. The extender 100 is coupled to the holding frame 300 and positions the front end of the bag filter assembly 200 at a location ahead of the holding frame 300 to maintain or reduce the length of the bag filter assembly 200 that extends out of the back end of the holding frame 300. The extender 100 is easily coupled to and uncoupled from the holding frame 300 using the attachment members 330, and the bag filter assembly 200 is easily coupled to and uncoupled from the extender 100 in a similar manner.

While the foregoing is directed to certain embodiments, other and further embodiments may be devised without departing from the basic scope thereof, and the scope thereof is determined by the claims that follow.

We claim:

1. A bag filter extender, comprising:
a quadrilateral tube having a centerline extending from a first open end to a second open end, the quadrilateral tube having a width at the first open end within a range of about 293 mm to about 598 mm and a depth within a range of about 278 mm to about 328 mm, the quadrilateral tube comprising:
an inner shoulder formed at the first open end and an outer shoulder formed at the second open end, wherein the inner and outer shoulders are parallel to each other and perpendicular to the centerline of the quadrilateral tube, and wherein an outer perimeter of the inner shoulder is substantially equal to or less than a size of an outer perimeter of a holding frame.

2. The extender of claim 1, wherein the quadrilateral tube comprises a top panel, a bottom panel, a right side panel, and a left side panel, wherein a front end of the top and bottom panels have a substantially L-shaped configuration, wherein a back end of the top panels have a substantially J-shaped configuration, and wherein a back end of the side panels have a substantially L-shaped configuration.

3. The extender of claim 2, wherein a front end and a back end of the right and left side panels have a substantially L-shaped configuration.

4. An air filtration system, comprising:
a holding frame; and
a bag filter extender having a first open end configured to accept a bag filter assembly and a second open end configured to engage the holding frame.

5. The system of claim 4, wherein the bag filter extender comprises:
a quadrilateral tube having a centerline extending from the first open end to the second open end, the quadrilateral tube comprising:
an inner shoulder formed at the first open end and an outer shoulder formed at the second open end, wherein the inner and outer shoulders are parallel to each other and perpendicular to the centerline of the quadrilateral tube.

6. The system of claim 5, wherein an outer perimeter of the inner shoulder is substantially equal to or less than a size of an outer perimeter of the holding frame.

7. The system of claim 5, wherein the quadrilateral tube comprises a width at the first open end within a range of about 293 mm to about 598 mm and a depth within a range of about 278 mm to about 328 mm.

8. The system of claim 4, further comprising a bag filter assembly disposed in the first open end of the bag filter extender.

9. The system of claim 8, wherein the bag filter assembly further comprises a filter media extending beyond the second open end of the extender.

10. The system of claim 4, wherein the bag filter extender has a depth within a range of about 278 mm to about 328 mm.

11. The system of claim 4, wherein a rear end of the bag filter extender is disposed within the holding frame.

12. The system of claim 4, wherein one or more attachment members secure the bag filter extender to the holding frame.

13. The system of claim 12, wherein the one or more attachment members comprise spring clips.

14. A method for reconfiguring an air filtration system configured for use with a longer bag filter assembly, comprising: installing one open end of a bag filter extender in a holding frame, the bag filter extender having an opposite open end configured to accept a bag filter assembly.

15. The method of claim 14, further comprising removing a first bag filter assembly from the holding frame, the first bag filter assembly having a filter media of a first length.

16. The method of claim 15, further comprising installing a second bag filter assembly in the opposite open end of the bag filter extender, the second bag filter assembly bag filter assembly having a filter media of a second length that is greater than the first length of the filter media of the first bag filter assembly.
